(19) United States
(12) Patent Application Publication
(10) Pub. No.: US 2015/0029598 A1
(43) Pub. Date: Jan. 29, 2015

(54) Variable rate focus mechanism

(71) Applicant: David Rogers Campbell, Richland, WA (US)

(72) Inventor: David Rogers Campbell, Richland, WA (US)

(21) Appl. No.: 13/987,423

(22) Filed: Jul. 24, 2013

(51) Int. Cl. G02B 7/10

(52) U.S. Cl. CPC G02B 7/10
USPC 359/701

(57) ABSTRACT

A focus mechanism has a removable and replaceable cam that allows selection of different rates of rotation and total axial displacement of a lens assembly. The rate and displacement are determined by the cam profile. The rate and displacement of the lens assembly can be selected by removing a cam with one profile and replacing it with another similar cam having a different profile. Rotation of an outer ring is coupled to the cam with drive pins.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

Focus mechanisms are common to photography to adjust the axial position of a lens assembly to cause coincidence of focal planes. In a manual system, rotation of an outer ring causes axial motion of the lens assembly. The rate of motion is determined by the rate of rotation of the ring.

### BRIEF SUMMARY OF THE INVENTION

The present Invention is an improved focus mechanism allowing the rotation of an outer focus ring to cause axial motion of the lens assembly, and allows for variation in the rate of motion of the lens assembly by means of a cam.

### BRIEF DESCRIPTION OF THE SEVERAL VIEWS OF THE DRAWINGS

FIG. 1 is an isometric view of the Invention where (1) is the outer ring, (2) is the cam and (3) and (4) are drive pins.

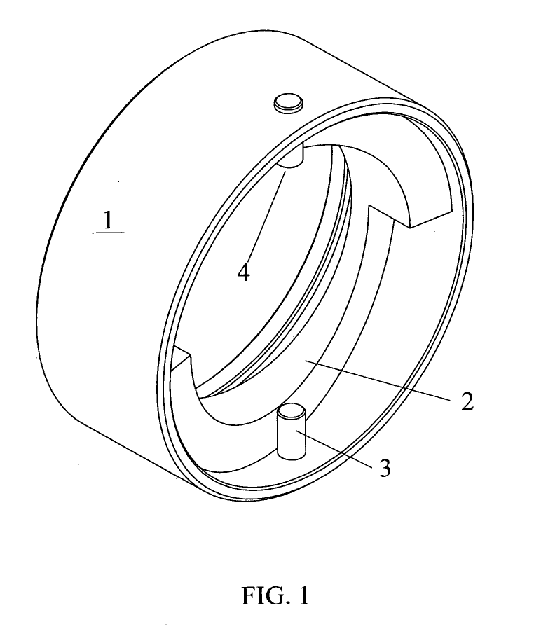

### DETAILED DESCRIPTION OF THE INVENTION

A lens assembly must be moved along its centerline to achieve focus. Usually a focus mechanism consists of an outer ring that is rotated to cause a corresponding axial motion in the assembly. The rate of axial movement depends on the rate of rotation of the outer ring and that relationship cannot be varied, for example, to select between a coarse movement rate, where one rotation of the ring causes a large axial movement, and a fine rate, where the same rotation results in a small axial movement. Such a selection is useful in achieving first a rough focus, then a very fine movement to set the exact focus. Such would be an advantage, for example, in photography with a high resolution digital sensor where the focus set by eye, at a coarse rate, might not cause the lens assembly to achieve a sufficiently accurate focus, and that resulting in the image, when enlarged, to be out of focus.

This limitation is solved in the present Invention by means of a cam with a profile that represents a movement rate and maximum movement distance, that can be removed and replaced with another similar cam having a different profile. The first cam could have a profile with a large displacement to allow quick acquisition of a rough focus position, then that cam removed and replaced with a second similar cam with a profile that allows a small displacement, for fine adjustment of the assembly position, thus the focus.

The mechanism has an outer focus ring which may be adjusted by hand with drive pins secured to the ring. The drive pins bear against the profile of the cam such that rotation of the ring causes rotation of the pins and displacement of the cam and the lens assembly coupled thereto, according to the profile and displacement of the cam profile.

The inventor claims:

1. An improved focus mechanism with which the axial position of a lens assembly may be adjusted at a selectable rate, the improvement comprising:
a. a focus ring concentric with said assembly,
b. drive pins to couple the rotation of said ring to said first cam
c. a first cam, concentric with said ring and mechanically coupled to said assembly, which when rotated, causes axial motion of said assembly according to the motion of said pins along the profile of said cam.

2. Said first cam being removable and replaceable with a second cam having a different profile.

3. Rotation of said ring causing rotation of said second cam, resulting in a different rate of motion of said assembly with respect to the rate of movement caused by said first cam.
